(19) United States
(12) Patent Application Publication
(10) Pub. No.: US 2025/0265566 A1
(43) Pub. Date: Aug. 21, 2025

(54) SYSTEMS AND METHODS FOR CHECK IMAGE DEPOSIT

(71) Applicant: JPMORGAN CHASE BANK, N.A., New York, NY (US)

(72) Inventors: Raghu VUDATHU, Downingtown, PA (US); Christy LILLIE, Ann Arbor, MI (US); Bodhi HWANG, Forest Hills, NY (US); Joe MARTEI, Brooklyn, NY (US); Mark LANTER, Woodside, NY (US)

(21) Appl. No.: 19/198,754

(22) Filed: May 5, 2025

Related U.S. Application Data
(63) Continuation of application No. 17/817,484, filed on Aug. 4, 2022.

(51) Int. Cl. G06Q 20/32; G06Q 40/02

(52) U.S. Cl. CPC G06Q 20/3223; G06Q 40/02

(57) ABSTRACT

Systems and methods for check image deposit are disclosed. In one embodiment, a method for bulk check image deposit may include: (1) capturing, by a computer application executed by an electronic device, a plurality of check images for a plurality of checks comprising an image of a first side of each check and an image of a second side of each check; (2) submitting, by the computer application, the plurality of check images to a backend in a deposit transaction; (3) matching, by a check recognition computer program at the backend, the images of the first side of the checks with the images of the second sides of the checks; (4) validating, by a deposit service computer program executed by the backend, the matched images for each of the checks; and (5) depositing, by the deposit service computer program, the validated checks.

### BACKGROUND OF THE INVENTION

### 1. Field of the Invention

Embodiments generally relate to systems and methods for electronic check deposit.

### 2. Description of the Related Art

Image-based check deposit has made depositing checks more convenient, but it can still be a slow process when depositing multiple checks. Users are required to capture images of the front and back of each check and then deposit them individually. The process is repeated for each check to be deposited.

### SUMMARY OF THE INVENTION

Systems and methods for check image deposit are disclosed. In one embodiment, a method for bulk check image deposit may include: (1) capturing, by a computer application executed by an electronic device, a plurality of check images for a plurality of checks comprising an image of a first side of each check and an image of a second side of each check; (2) submitting, by the computer application, the plurality of check images to a backend in a deposit transaction; (3) matching, by a check recognition computer program at the backend, the images of the first side of the checks with the images of the second sides of the checks; (4) validating, by a deposit service computer program executed by the backend, the matched images for each of the checks; and (5) depositing, by the deposit service computer program, the validated checks.

In one embodiment, the plurality of check images may be received in a file. In one embodiment, the images of the first sides and the images of the second sides may be matched based on their sequence in the file.

In one embodiment, each image of a first side and each image of a second side may include an identifier that identifies the check, and the images of the first side and the images of the second side may be matched using the identifier. In one embodiment, the identifier may be a routing number, an account number, or a check number.

In one embodiment, the identifier may include a machine readable code.

In one embodiment, the check images may be validated for image quality, completeness, etc.

In one embodiment, the method may also include sending, by the deposit service computer program, a summary of a deposit status for each of the checks.

In one embodiment, the electronic device may be a mobile electronic device.

According to another embodiment, a method for bulk check image deposit may include: (1) capturing, by a computer application executed by an electronic device, a video comprising a plurality of first sides of checks and a plurality of second sides of the checks; (2) submitting, by the computer application, the video to a backend in a deposit transaction; (3) identifying, a check recognition computer program at the backend, images of the first sides and images of the second sides, wherein each image of the first side and each image of the second side comprises an identifier that identifies the check; (4) matching, by the check recognition computer program, the first sides with the second sides using the identifier; (5) validating, by a deposit service computer program executed by the backend, the matched images of each of the checks; and (6) depositing, by the deposit service computer program, the validated checks.

In one embodiment, the identifier may include a routing number, an account number, or a check number. In one embodiment, the identifier may be a machine readable code.

In one embodiment, the check images may be validated for image quality, completeness, etc.

In one embodiment, the method may also include sending, by the deposit service computer program, a summary of a deposit status for each of the checks.

According to another embodiment, a non-transitory computer readable storage medium, including instructions stored thereon, which when read and executed by one or more computer processors, cause the one or more computer processors to perform steps including: (1) receiving a plurality of check images for a plurality of checks comprising an image of a first side of each check and an image of a second side of each check; (2) matching the images of the first side of the checks with the images of the second sides of the checks; (3) validating the matched images for each of the checks; and (5) depositing the validated checks.

In one embodiment, the plurality of check images may be received in a file, and the images of the first sides and the images of the second sides may be matched based on their sequence in the file.

In one embodiment, each image of a first side and each image of a second side may include an identifier that identifies the check, and the images of the first side and the images of the second side are matched using the identifier.

According to another embodiment, a system for bulk check image deposit may include a financial institution backend executing a check recognition computer program and a deposit service computer program, and a customer electronic device that may execute a banking application and may include an image capture device. The banking application may capture a plurality of check images for a plurality of checks comprising an image of a first side of each check and an image of a second side of each check and may submit the plurality of check images to a backend in a deposit transaction. The check recognition computer program may match the images of the first side of the checks with the images of the second sides of the checks. The deposit service computer program may validate the matched images for each of the checks and may deposit the validated checks to an identified account.

In one embodiment, the plurality of check images may be received in a file. In one embodiment, the images of the first sides and the images of the second sides may be matched based on their sequence in the file.

In one embodiment, each image of a first side and each image of a second side may include an identifier that identifies the check, and the images of the first side and the images of the second side may be matched using the identifier. In one embodiment, the identifier may be a routing number, an account number, or a check number.

In one embodiment, the identifier may include a machine readable code.

In one embodiment, the check images may be validated for image quality, completeness, etc.

In one embodiment, the deposit service computer program may send a summary of a deposit status for each of the checks.

In one embodiment, the electronic device may be a mobile electronic device.

According to another embodiment, a system for bulk check image deposit may include a financial institution backend executing a check recognition computer program and a deposit service computer program, and a customer electronic device that may execute a banking application and may include an image capture device. The banking application may capture a video comprising a plurality of first sides of checks and a plurality of second sides of the checks and may submit the video to a backend in a deposit transaction. The check recognition computer program at the backend may identify images of the first sides and images of the second sides, wherein each image of the first side and each image of the second side comprises an identifier that identifies the check and may match the first sides with the second sides using the identifier. The deposit service computer program executed by the backend may validate the matched images of each of the checks; and deposit by the deposit service computer program, the validated checks to an identified account.

In one embodiment, the identifier may include a routing number, an account number, or a check number. In one embodiment, the identifier may be a machine readable code.

In one embodiment, the check images may be validated for image quality, completeness, etc.

In one embodiment, the deposit service computer program may send a summary of a deposit status for each of the checks.

### BRIEF DESCRIPTION OF THE DRAWINGS

In order to facilitate a fuller understanding of the present invention, reference is now made to the attached drawings in which:

FIG. 1 discloses a system for check image deposit according to one embodiment;

FIG. 2 depicts a method for check image deposit according to one embodiment;

FIG. 3 depicts a method for check image deposit according to another embodiment;

FIG. 4 depicts a method for check image deposit according to yet another embodiment; and

FIG. 5 depicts an exemplary computing system for implementing aspects of the present disclosure.

### DETAILED DESCRIPTION OF PREFERRED EMBODIMENTS

Systems and methods for check image deposit are disclosed.

Embodiments enable the deposit of a plurality of checks from an electronic device in a single interaction, and provide the ability to capture check images in a plurality of images, a single image, a video (e.g., a collection of images), etc. The images and or video may be in any suitable format.

Embodiments identify the boundaries of checks in images, and may match images of the different sides of a check based on a sequence or by using a check identifier that may be present on both sides of the check.

Because a plurality of checks may be deposited in a single interaction, embodiments may reduce computational energy expended by the customer electronic device. Embodiments may reduce the amount of communications between the customer electronic device and the financial institution backend, thereby reducing the amount of bandwidth used compared to depositing each check individually.

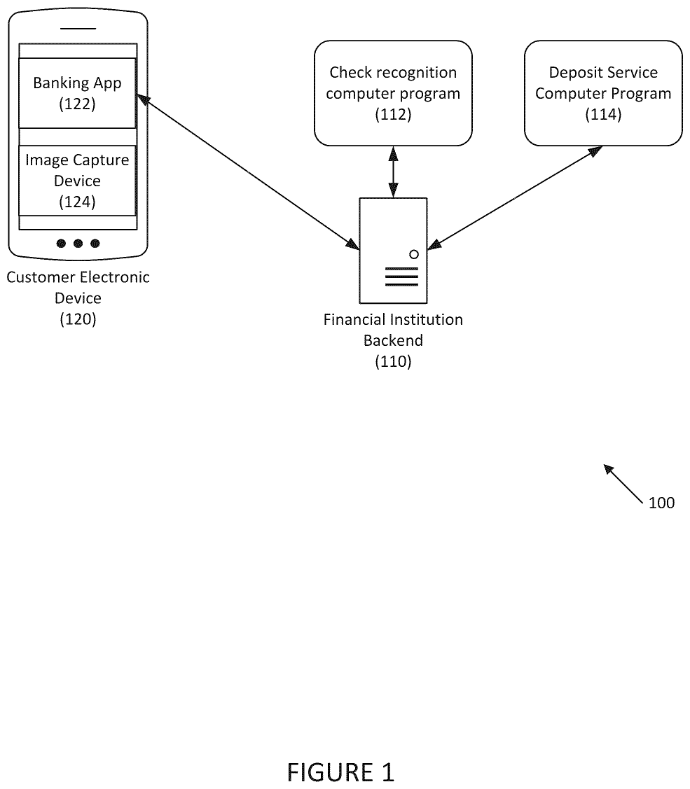

Referring to FIG. 1, a system for check image deposit is disclosed according to one embodiment. System 100 may include financial institution backend 110, which may include a computer (e.g., physical and/or virtual servers, etc.), customer electronic device 120, and deposit service computer program 114. Financial institution backend 110 may execute check recognition computer program 112, which may receive and process images of checks in bulk. Check recognition computer program 112 may communicate with banking application 122 that may be executed by customer electronic device 120.

Financial institution backend 110 may also execute deposit service computer program 114, which may receive processed checks from check recognition computer program 112 and may cause the checks to be deposited to an account for the customer. Deposit service computer program 114 may also communicate with banking application 122 directly or financial institution backend 110 to provide a status of the deposit.

Deposit service computer program 114 may review to determine acceptance or rejection (e.g., fraud, duplicate, stop pay, etc.). If a check is accepted, it will then get released to another backend enterprise system for posting, and the processed check images may be sent to a data warehouse (not shown) for storage and access.

Customer electronic device 120 may further include image capture device 124, such as a camera or other suitable device, for capturing images or video (e.g., a series of images) of checks. Customer electronic device 120 may be smart phone, computer (e.g., desktop, notebook, tablet, etc.), an Internet of Things (IoT) appliance, etc.

In one embodiment, customer electronic device 120 may be provided as a kiosk, an ATM, a check scanner, etc.

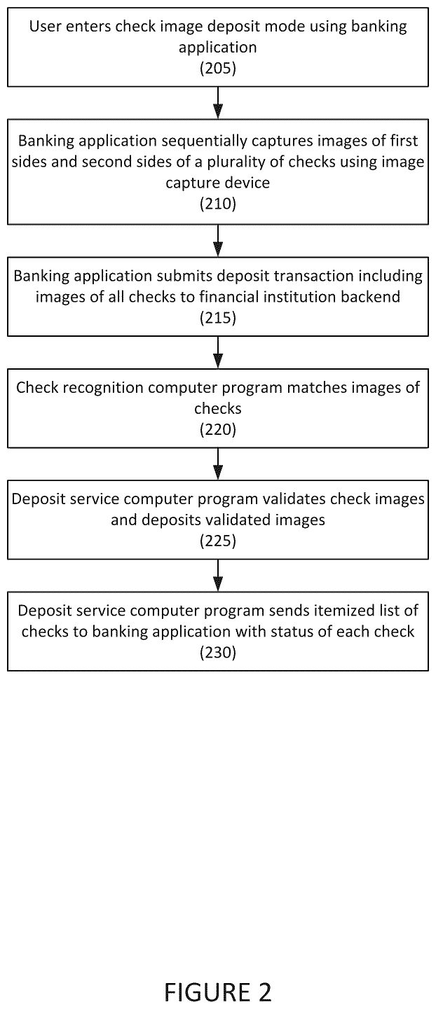

Referring to FIG. 2, a method for check image deposit is disclosed according to one embodiment. In step 205, a user, such as a bank customer, may enter a check deposit mode using, for example, a banking application executed on an electronic device.

In another embodiment, the banking application may be provided on a kiosk, ATM, check scanning device, etc.

In step 210, using the banking application, the user may sequentially capture images of a first side (e.g., a front side) and a second side (e.g., a back side) of a plurality of checks using an image capture device, such as a camera on the electronic device. For example, the banking application may capture an image of the first side of a first check, the second side of the first check, the first side of a second check, the second side of a second check, etc. Because the check images will be matched based on sequence, the “first sides” do not all have to be the fronts of checks, nor do the “second sides” have to be the backs of the checks.

In one embodiment, the banking application may require that the image capture device on the electronic device be used to capture the images. Thus, images may not be permitted to be retrieved from a photo library.

In step 215, the banking application may submit the images of all checks to a financial institution backend, which may then send the images to a check recognition computer program. In one embodiment, the images of the checks may be submitted in a file.

In step 220, the check recognition computer program may match the images of the checks. For example, the check recognition computer program may match images based on the sequence in which the check images are received.

In step 225, a deposit service computer program may process may validate the check images. For example, the deposit service computer program may review the checks for duplicate presentation, fraud, negotiability review (e.g., check image includes a name, a date, an amount, an endorsement, and a signature), deposit limits, etc. In one embodiment, deposit service computer program may generate an image score for the image and, if the image score is above a threshold, and that key elements are present (e.g., successful negotiability review, that the entered deposit amount matches amount in check image, etc.) before it is sent to the deposit service program.

The deposit service computer program may create and submit a deposit transaction for checks with valid images.

In step 230, the deposit service computer program may return an itemized list of the checks with a status of each check to the banking application.

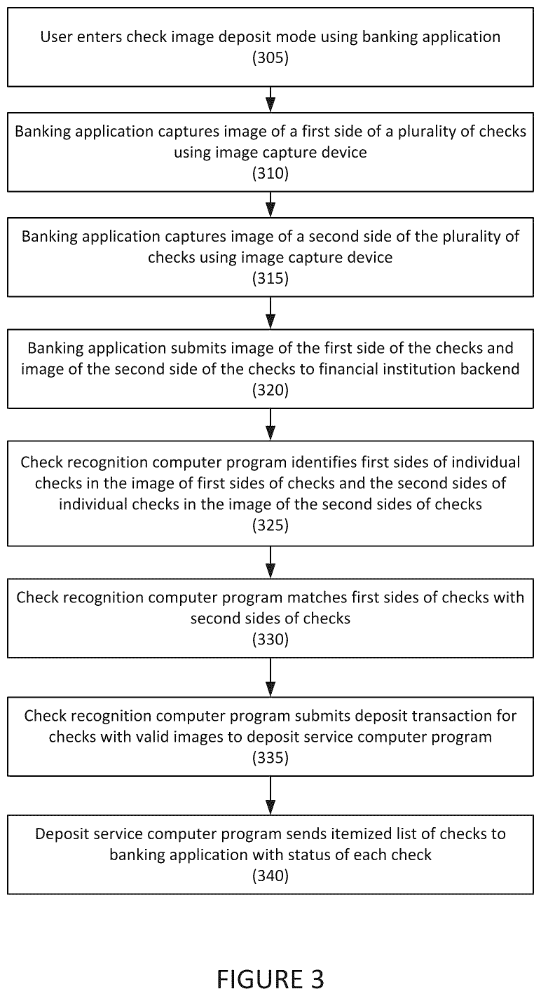

Referring to FIG. 3, a method for check image deposit is disclosed according to one embodiment. In step 305, a user, such as a bank customer, may enter a check image deposit mode using, for example, a banking application executed on a mobile electronic device.

In step 310, using the banking application, the user may capture an image of a first side of a plurality of checks using an image capture device, such as a camera on the electronic device. For example, the user may lay out the checks on a table, on the floor, etc. and may capture a single image of the checks.

In one embodiment, the first side may be the front side of a check, the back side of a check, etc. The first side need not be the same side for all checks.

In step 315, using the banking application, the user may capture an image of a second side of the plurality of checks using the image capture device on the electronic device. For example, before capturing the image, the user may flip each check over to present the second side of the check to the image capture device.

In step 320, the banking application may submit the image of the first sides of the checks and the image of the second sides of the checks to a financial institution backend, which may provide the images to a check recognition computer program.

In step 325, the check recognition computer program may identify the first side of each individual checks in the image of the first sides of the checks, and the second side of each individual check in the image of second sides of the checks. Any suitable image processing technique may be used to identify the first sides and the second sides of the individual checks.

In step 330, the check recognition computer program may match the first sides of the checks with the second sides of the checks. In one embodiment, each check may have an indicator on the front and the back of the check that may be used to match a front with a back. For example, the indicator may be a routing number, account number, and check number, a machine-readable code (e.g., a bar code, QR code, etc.). Examples of such indicators are disclosed in U.S. patent application Ser. No. 17/663,174, filed May 12, 2022, the disclosure of which is hereby incorporated, by reference, in its entirety.

In step 335, the check recognition computer program may submit a deposit transaction for checks with valid images to a deposit service computer program.

In step 340, the deposit service computer program may deposit the checks with valid images and may return an itemized list of the checks with a status of each check to the banking application.

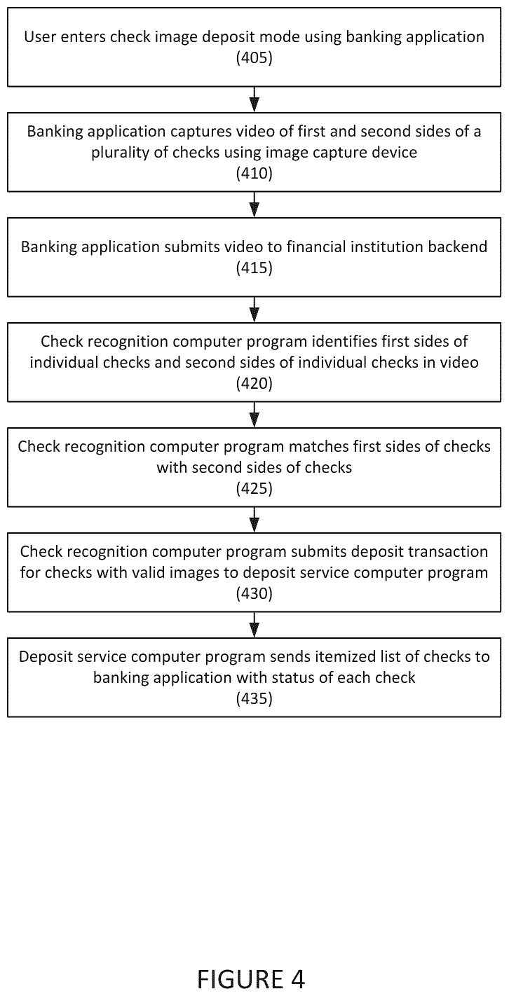

Referring to FIG. 4, a method for check image deposit is disclosed according to one embodiment. In step 405, a user, such as a bank customer, may enter a check image deposit mode using, for example, a banking application executed on a mobile electronic device.

In step 410, using the banking application, the user may capture a video of a first side of a plurality of checks and a second side of the plurality of checks using an image capture device, such as a camera on the electronic device. For example, the user may lay out the checks on a table, on the floor, etc. and may capture a single video of the first side of the checks, and then flip the checks to capture the second side.

In one embodiment, the user may capture two videos, one of the first side of the checks and one of the second side of the checks.

In step 415, the banking application may submit the video(s) of the first sides of the checks and the second sides of the checks to a financial institution backend, which may provide the images to a check recognition computer program.

In step 420, the check recognition computer program may identify the first side of each individual checks and the second side of each individual check in the video. Any suitable image processing technique may be used to identify the first sides and the second sides of the individual checks.

In step 425, the check recognition computer program may match the first sides of the checks with the second sides of the checks. This may be similar to step 330, above.

In step 430, the check recognition computer program may submit a deposit transaction for checks with valid images to a deposit service computer program.

In step 435, the deposit service computer program may deposit the checks with valid images and may return an itemized list of the checks with a status of each check to the banking application.

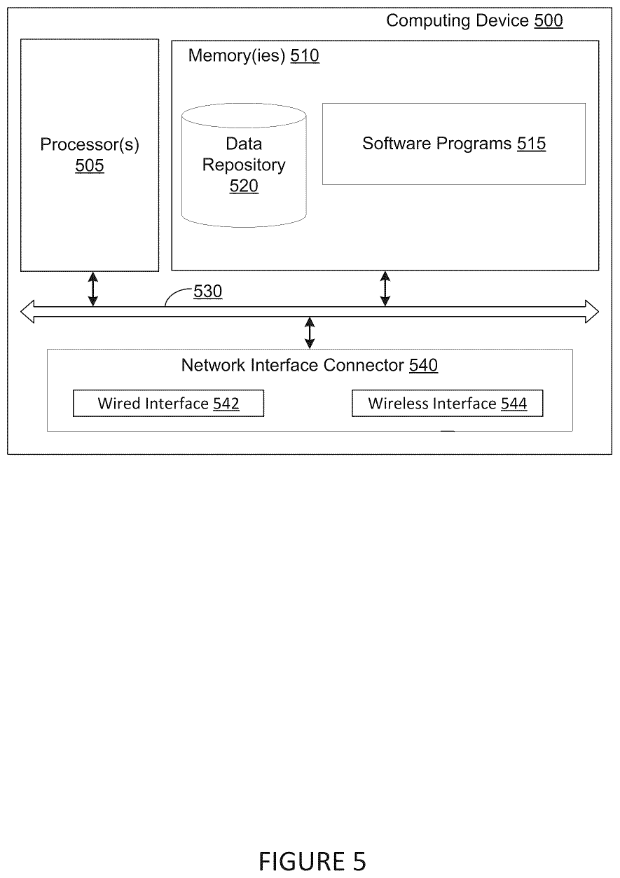

FIG. 5 depicts an exemplary computing system for implementing aspects of the present disclosure. FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for bulk check image deposit, comprising:
capturing, by a computer application executed by an electronic device, a plurality of check images for a plurality of checks comprising an image of a first side of each check and an image of a second side of each check;
submitting, by the computer application, the plurality of check images to a backend in a deposit transaction;
matching, by a check recognition computer program at the backend, the images of the first side of the checks with the images of the second sides of the checks;
validating, by a deposit service computer program executed by the backend, the matched images for each of the checks; and
depositing, by the deposit service computer program, the validated checks.

2. The method of claim 1, wherein the plurality of check images are received in a file.

3. The method of claim 2, wherein the images of the first sides and the images of the second sides are matched based on their sequence in the file.

4. The method of claim 1, wherein each image of a first side and each image of a second side comprises an identifier that identifies the check, and the images of the first side and the images of the second side are matched using the identifier.

5. The method of claim 4, wherein the identifier comprises one of a routing number, an account number, and a check number.

6. The method of claim 4, wherein the identifier comprises a machine readable code.

7. The method of claim 1, wherein the check images are validated for image quality.

8. The method of claim 1, wherein the check images are validated for completeness.

9. The method of claim 1, further comprising:
sending, by the deposit service computer program, a summary of a deposit status for each of the checks.

10. The method of claim 1, wherein the electronic device comprises a mobile electronic device.

11. A method for bulk check image deposit, comprising:
capturing, by a computer application executed by an electronic device, a video comprising a plurality of first sides of checks and a plurality of second sides of the checks;
submitting, by the computer application, the video to a backend in a deposit transaction;
identifying, a check recognition computer program at the backend, images of the first sides and images of the second sides, wherein each image of the first side and each image of the second side comprises an identifier that identifies the check;
matching, by the check recognition computer program, the first sides with the second sides using the identifier;
validating, by a deposit service computer program executed by the backend, the matched images of each of the checks; and
depositing, by the deposit service computer program, the validated checks.

12. The method of claim 11, wherein the identifier comprises one of a routing number, an account number, and a check number.

13. The method of claim 11, wherein the identifier comprises a machine readable code.

14. The method of claim 11, wherein the check images are validated for image quality.

15. The method of claim 11, wherein the check images are validated for completeness.

16. The method of claim 11, further comprising:
sending, by the deposit service computer program, a summary of a deposit status for each of the checks.

17. A non-transitory computer readable storage medium, including instructions stored thereon, which when read and executed by one or more computer processors, cause the one or more computer processors to perform steps comprising:
receiving a plurality of check images for a plurality of checks comprising an image of a first side of each check and an image of a second side of each check;
matching the images of the first side of the checks with the images of the second sides of the checks;
validating the matched images for each of the checks; and
depositing the validated checks.

18. The non-transitory computer readable storage medium of claim 17, wherein the plurality of check images are received in a file.

19. The non-transitory computer readable storage medium of claim 18, wherein the images of the first sides and the images of the second sides are matched based on their sequence in the file.

20. The non-transitory computer readable storage medium of claim 17, wherein each image of a first side and each image of a second side comprises an identifier that identifies the check, and the images of the first side and the images of the second side are matched using the identifier.
